(19) United States
(12) Patent Application Publication
(10) Pub. No.: US 2021/0406093 A1
(43) Pub. Date: Dec. 30, 2021

(54) COMPUTING MACHINE, METHOD AND NON-TRANSITORY COMPUTER-READABLE MEDIUM

(71) Applicants: NEC CORPORATION, Tokyo (JP); PHOTONICS ELECTRONICS TECHNOLOGY RESEARCH ASSOCIATION, Tokyo (JP)

(72) Inventor: Kenji MIZUTANI, Tokyo (JP)

(73) Assignees: NEC CORPORATION, Tokyo (JP); PHOTONICS ELECTRONICS TECHNOLOGY RESEARCH ASSOCIATION, Tokyo (JP)

(21) Appl. No.: 17/356,797

(22) Filed: Jun. 24, 2021

(30) Foreign Application Priority Data
Jun. 25, 2020 (JP) 2020-109694

(51) Int. Cl. G06F 9/54; G06F 9/38

(52) U.S. Cl. CPC G06F 9/54; G06F 9/3881; G06F 9/3869; G06F 9/3885

(57) ABSTRACT

A computing machine according to the present disclosure includes: control managing means for controlling communication between a plurality of computing machines; and management register means for managing communication setting information which sets communication between the computing machines and communication state information which indicates a state of the communication. The computing machine includes edge control means for, upon receiving a signal from one of the computing machines, sorting the signal into a control signal and data based on the communication setting information set in the management register means and in accordance with the number of clocks for processing the signal.

### INCORPORATION BY REFERENCE

This application is based upon and claims the benefit of priority from Japanese patent application No. 2020-109694, filed on Jun. 25, 2020, the disclosure of which is incorporated herein in its entirety by reference.

### TECHNICAL FIELD

The present disclosure relates to a computing machine, a method and a program.

### BACKGROUND ART

In a parallel computing machine system, a large problem that cannot be handled by a single computing machine is divided into multiple pieces and the resulting smaller problems are processed by multiple computing machines in parallel at high speed. In handling of a large problem, one problem is commonly processed by multiple computing machines in a parallel computing machine system because handling of multiple problems leads to collision between computations or communications corresponding to individual problems, which deteriorates efficiency of calculation. In execution of parallel computation in a parallel computing machine system, performance of a network that connects between computing machines is important. For the network, one that connects many computing machines with a small amount of wiring is used, such as a mesh, torus or tree topology. This can keep wiring costs required for introduction of the network low.

In a parallel computing machine system, data need to be passed via multiple computing machines. It is thus necessary to determine at each computing machine to which computing machine information should be passed. To that end, data is divided into a certain size and turned into a frame with addition of different kinds of control information, such as destination and data size, for each of the resulting data. Then, each computing machine has to check the control information on a per-frame basis and determine whether to process data on its own or to send it to the next computing machine. In order to perform such complicated frame processing at high speed, it is necessary to prepare memory with low delay such as SRAM (Static Random Access Memory), prepare a lookup table for control information, and instantaneously decide how to handle the control information. Consequently, not only a large quantity of SRAM is required for network-related processing but a determination circuit is also necessary for each piece of control information, which consumes a large amount of arithmetic resource. Additionally, the size of control information is not negligible and efficiency in transfer of a small piece of information deceases as well.

Further, delay in the network also poses a problem in parallel computation. Delay can be caused by various factors. Since it is conventionally necessary to move data itself across multiple computing machines, a transit time at each computing machine is also a factor in increasing delay. This transit time also includes processing of the control information in the frame mentioned above. A parallel computing machine system made up of N computing machines typically requires the number of communications of Log₂N.

Further, parallel computing machines require notification of Barrier for aligning time axes among the computing machines and/or of reception state for reliable sending of data. Time taken for such notifications is also a factor in increasing delay. The time required for such notifications also needs to go across multiple computing machines; in a system made up of N computing machines, delay will typically increase in proportion to Log₂N.

Various techniques for lowering delay in a parallel computing machine system have been proposed. Japanese Patent No. 5304194 discloses a technique related to Barrier control. Here, an overview of Barrier control is briefly shown. In a computation program, a point of Barrier synchronization (hereinafter “Barrier point”) is set. When each computing machine has reached processing at the Barrier point, it temporarily stops computation. Then, the computing machine checks whether the other computing machines have reached the Barrier point. After checking that all the computing machines have reached the Barrier point, the temporarily stopped computation is restarted. Further, Japanese Patent No. 5304194 discloses a method of sharing information on whether the Barrier point has been reached among computing machines. A computing machine that has reached the Barrier point notifies the respective computing machines of the fact by broadcasting it. Each computing machine restarts its computation upon recognizing Barrier notifications from all the computing machines. Such a mechanism has been provided in hardware, including part of frame processing.

However, further reduction in delay is desirable given the recent improvement in arithmetic performance due to development in finer arithmetic chips such as CPUs (Central Processing Units) and GPUs (Graphic Processor Units), and FPGAs (Field Programmable Gate Arrays). However, embodying all of the complicated frame processing as shown above in hardware will require even more logics for computations. Also, the number of communications of Log₂N, which is necessary in a conventional network with a small amount of wiring, cannot be reduced only by a hardware solution. Reduction in control time that also takes such multiple times of communications into consideration is necessary.

At the same time, there have been proposals of various techniques for reducing the number of communications. Japanese Patent No. 3292843 and U.S. Pat. No. 9,401,774 disclose techniques that uses optical communication technology to achieve full-mesh connection with a small amount of wiring. Since in such a system each computing machine is connected by a passive optical component, the number of transceivers can be reduced as well.

The aforementioned related techniques require each computing machine to have input/output ports as many as the number of computing machines connected with it and a switch for selecting from those ports; however, there has been no mechanism for efficient control between multiple computing machines via such a large number of ports with low delay.

In achieving such control, increase in circuit scale for control would also be a problem if the frame processing described in Background is introduced directly. This is because input/output ports as many as the number of computing machines are required per computing machine. If control is performed after aggregating the input/output ports, the circuit scale can be kept low but the time taken for control would increase. Individual control at each input/output port is desired. However, it would require separate control mechanisms as many as the number of computing machines, leading to an increased circuit scale. For example, an increased circuit scale results in decrease in logics necessary for computations, which leads to lower arithmetic performance. Thus, there has been an issue of difficulty in realizing communication functions having no resource burden and low delay in a computing machine system connected in full mesh.

To overcome this issue, an object of the present disclosure is to provide a computing machine, a method and a program that can realize communication functions with no resource burden and with low delay.

### SUMMARY

A computing machine according to the present disclosure includes: control managing means for controlling communication between a plurality of computing machines; management register means for managing communication setting information which sets communication between the computing machines and communication state information which indicates a state of the communication; and edge control means for, upon receiving a signal from one of the computing machines, sorting the signal into a control signal and data based on the communication setting information set in the management register means and in accordance with the number of clocks for processing the signal.

A method according to the present disclosure includes the steps of: receiving, by a first computing machine, a signal from a second computing machine which executes parallel computation with the first computing machine; and upon receiving the signal, sorting, by the first computing machine, the signal into a control signal and data based on communication setting information which is preset for communication between the first computing machine and the second computing machine and in accordance with the number of clocks for processing the received signal.

A non-transitory computer-readable medium according to the present disclosure stores a program for causing a first computing machine to perform the steps of: storing, by the first computing machine, a signal received from a second computing machine which executes parallel computation with the first computing machine; and upon receiving the signal, sorting the signal into a control signal and data based on communication setting information which is preset for communication between the first computing machine and the second computing machine and in accordance with the number of clocks for processing the received signal.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a configuration of a computing machine according to a first example embodiment;

FIG. 2 is a block diagram illustrating an example of configuration of a parallel computing machine system according to a second example embodiment;

FIG. 3 is a block diagram showing a configuration of a computing machine according to the second example embodiment;

FIG. 4 is a table representing a management table of a management register unit according to the second example embodiment;

FIG. 5 is a timing chart of signals that are transmitted by an edge control unit according to the second example embodiment to a partner computing machine;

FIG. 6 is a process chart illustrating an operational status of an arithmetic processing unit of each computing machine in patterns P2 to P6 in the parallel computing machine system according to the second example embodiment;

FIG. 7A is a table showing register information in the management register unit of each computing machine for the pattern P2 in the parallel computing machine system according to the second example embodiment;

FIG. 7B is a process chart illustrating the operational status of the arithmetic processing unit of each computing machine with the pattern P2 in the parallel computing machine system according to the second example embodiment;

FIG. 8A is a table showing register information in the management register unit of the computing machine for the pattern P3 in the parallel computing machine system according to the second example embodiment;

FIG. 8B is a process chart illustrating the operational status of the arithmetic processing unit of each computing machine with the pattern P3 in the parallel computing machine system according to the second example embodiment;

FIG. 9A is a table showing register information in the management register unit of the computing machine for the patterns P4 and P5 in the parallel computing machine system according to the second example embodiment;

FIG. 9B is a process chart illustrating the operational status of the arithmetic processing unit of each computing machine with the patterns P4 and P5 in the parallel computing machine system according to the second example embodiment;

FIG. 10A is a table showing register information in the management register unit of the computing machine for the pattern P6 in the parallel computing machine system according to the second example embodiment;

FIG. 10B is a process chart illustrating the operational status of an arithmetic processing unit of each computing machine with the pattern P6 in the parallel computing machine system according to the second example embodiment;

FIG. 11 is a timing chart showing band degradation in signals transmitted by the computing machine according to the second example embodiment;

FIG. 12 is a timing chart of signals which are transmitted to the partner computing machine by the edge control unit according to a third example embodiment;

FIG. 13 is a schematic diagram showing an issue that can occur in an application that uses a great deal of one-way communication in the parallel computing machine system according to the second example embodiment;

FIG. 14 is a block diagram showing a configuration of a computing machine according to a fourth example embodiment; and

FIG. 15 is a block diagram showing a configuration of a computing machine according to a fifth example embodiment.

### EXAMPLE EMBODIMENT

Specific example embodiments to which the present disclosure is applied will now be described in detail with reference to the drawings. In the drawings, the same elements are given the same signs and redundant descriptions are omitted where necessary for the sake of clarity.

### First Example Embodiment

A first example embodiment of the present disclosure is described below.

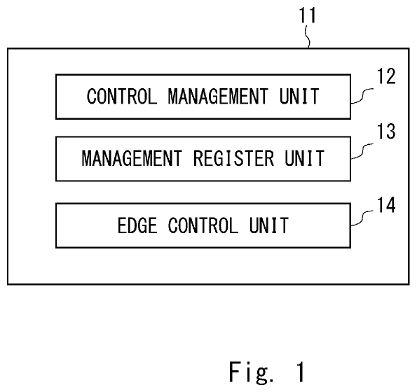

A computing machine 11 included in a parallel computing machine system 1 according to the first example embodiment is described first. FIG. 1 is a block diagram showing a configuration of the computing machine 11 according to the first example embodiment. The parallel computing machine system 1 according to the first example embodiment fully connects multiple computing machines 11 (connects them in full mesh). The computing machine 11 includes a control management unit 12, a management register unit 13 and an edge control unit 14.

The control management unit 12 controls communication between the multiple computing machines. The management register unit 13 manages communication setting information which sets communication between computing machines and communication state information which indicates a state of the communication. Upon receiving a signal from a computing machine, the edge control unit 14 sorts the signal into a control signal and data based on the communication setting information set in the management register unit 13 and in accordance with the number of clocks for processing the signal.

Thus, the computing machine 11 according to the first example embodiment can minimize resources for control between multiple computing machines. Specifically, the computing machine 11 uses as minimum as one type of control signal. Further, the computing machine 11 does not use pattern recognition of multiple complicated signals. The computing machine 11 can thus minimize the quantity of registers for managing a network.

The computing machine 11 can also minimize a delay involved in control between computing machines. Specifically, the computing machine 11 realizes communication between the fully connected computing machines by a simple control scheme. Thus, the computing machine 11 not only reduces the number of communications required for control by full connection to one but enables separation of data and a control signal only by determining the number of clocks of the control signal and allows instantaneous grasping of states between computing machines.

### Second Example Embodiment

A second example embodiment of the present disclosure is now described.

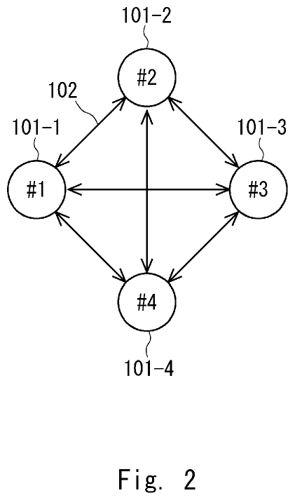

First, referring to FIG. 2, an example of configuration of a parallel computing machine system 2 according to the second example embodiment is described. FIG. 2 is a block diagram showing an example of configuration of the parallel computing machine system 2 according to the second example embodiment. The parallel computing machine system 2 includes a computing machine 101-1, a computing machine 101-2, a computing machine 101-3 and a computing machine 101-4. For the sake of description, the computing machine 101-1, the computing machine 101-2, the computing machine 101-3 and the computing machine 101-4 in the parallel computing machine system 2 according to the second example embodiment will be denoted hereinafter as computing machine #1, computing machine #2, computing machine #3, and computing machine #4, respectively. In the parallel computing machine system 2, the computing machine 101-1 to the computing machine 101-4 are fully connected (connected in full mesh) and exchange data and control with each other. On the respective computing machines, the same program is run and parallel computations are performed. Preferably, only a single program is run on each computing machine.

The parallel computing machine system 2 according to the second example embodiment is implemented on an FPGA, an accelerator capable of dynamic reconfiguration of circuitry. FPGAs do not allow high wiring density compared to ASICs (Application Specific Integrated Circuits) such as GPUs, and are limited in resources that can be utilized with it. However, a control mechanism for the parallel computing machine system 2 according to the second example embodiment is implemented with less resource, leaving resources for program execution.

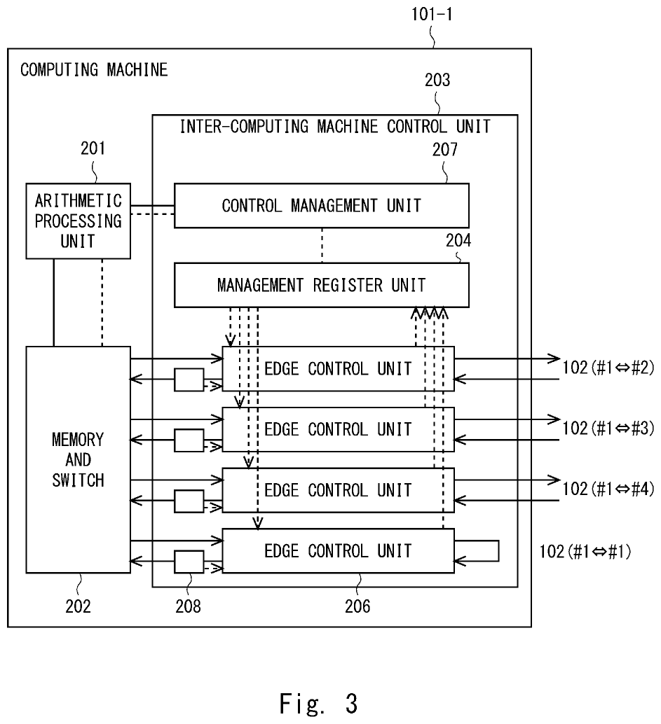

Next, referring to FIG. 3, the configuration of the computing machine 101-1 according to the second example embodiment is described. FIG. 3 is a block diagram showing a configuration of the computing machine 101-1 according to the second example embodiment. The computing machine 101-2, the computing machine 101-3 and the computing machine 101-4 have similar configurations to that of the computing machine 101-1. The computing machine 101-1 includes an arithmetic processing unit 201, a memory and switch 202, and an inter-computing machine control unit 203. The inter-computing machine control unit 203 is directly connected to links 102, which connect between the computing machines. The links 102 also include a link that turns back within the computing machine itself.

The arithmetic processing unit 201 offloads operations related to sharing between computing machines and executes controls between computing machines instantaneously. This offloading realizes control with low delay via instantaneous execution. The arithmetic processing unit 201 may be a microprocessor, an MPU (Micro Processing Unit), or a CPU, for example.

The memory and switch 202 stores data that is shared between computing machines. It is formed from combination of volatile memory and nonvolatile memory. The memory and switch 202 may include a storage located apart from the arithmetic processing unit 201. In this case, the arithmetic processing unit 201 may access the memory and switch 202 by way of an I/O interface, not shown.

The inter-computing machine control unit 203 controls communication between computing machines. The inter-computing machine control unit 203 includes a management register unit 204, edge control units 206, a control management unit 207, and a FIFO (First In First Out) memory 208.

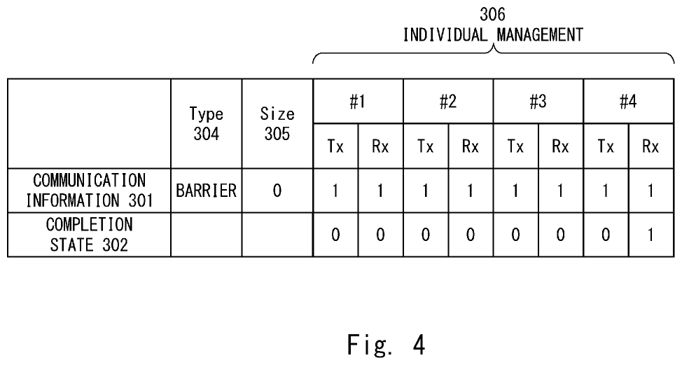

The management register unit 204 stores communication setting information which sets communication between computing machines and communication state information which indicates the state of the communication in the management table shown in FIG. 4. FIG. 4 is a table representing the management table of the management register unit 204 according to the second example embodiment. The management table indicates register values stored for each block in the management register unit 204. The management table has entries of communication information 301 and completion state 302 in row direction. The management table includes entries of Type 304, Size 305 and individual management 306 in column direction. Here, the communication setting information, which sets communication between computing machines, is stored in the Type 304 and the Size 305 entries in the management table. Communication state information indicating the state of the communication is stored in the individual management 306 entry.

In the description below, denotation “column entry/row entry” is used. An example is “communication information 301/Tx of #2 of the individual management 306”.

The Type 304 manages the communication scheme of the computing machine 101-1 in the parallel computing machine system 2. The communication scheme can be Barrier, reception confirmation and SendRecv as PtoP communication, Scatter and Gather as well as Alltoall and Allgather, which are collective communication, etc. The Size 305 manages the data size of data which is transmitted and received by the computing machine 101-1. Tx of the individual management 306 manages the transmission state when the computing machine 101-1 transmits a signal to a computing machine connected with it. Rx of the individual management 306 manages the reception state when the computing machine 101-1 receives a signal from a computing machine connected with it.

The communication information 301 is an entry that manages information on communication performed by the computing machine 101-1. When the computing machine 101-1 shown in FIG. 2 performs communication with a computing machine as the other party of communication (hereinafter “partner computing machine”) by means of Barrier, for example, “communication information 301/Type 304” is “Barrier”. In that case, since in Barrier no data is transmitted to the partner computing machine, that is, only a control signal is transmitted, “communication information 301/Size 305” is “0”. Further, when the computing machine 101-1 transmits a signal to the partner computing machine, the value of the “communication information 301/Tx of the partner computing machine of the individual management 306” becomes “1”. When the computing machine 101-1 receives a signal from the partner computing machine, the value of the “communication information 301/Rx of the partner computing machine of the individual management 306” becomes “1”. Otherwise, the values of Tx and Rx are “0”.

The completion state 302 is an entry that manages whether communication performed with the communication information 301 has been completed or not. Accordingly, the Type 304 and the Size 305 entries are common to the communication information 301. For example, when the computing machine 101-1 has completed transmission of a signal to the partner computing machine, the value of “completion state 302/Tx of the partner computing machine of the individual management 306” is “1”. By contrast, when the computing machine 101-1 has completed reception of a signal from the partner computing machine, the value of “completion state 302/Rx of the partner computing machine of the individual management 306” is “1”.

The edge control unit 206 is now described in detail. The edge control unit 206 has five functions (1) to (5).

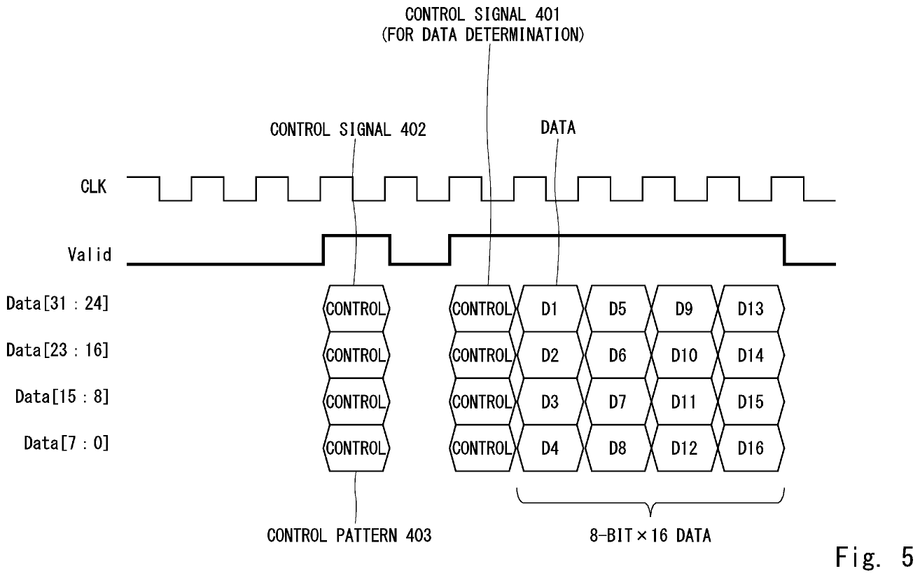

(1) The edge control unit 206 has a function of sorting a signal into a control signal and data. Referring to FIG. 5, an example of signals transmitted by the edge control unit 206 is described. FIG. 5 is a timing chart of signals that are transmitted by the edge control unit 206 to the partner computing machine. CLK, Valid and Data[a:b] indicate signals in a clock lane, a Valid lane, and data lanes, respectively, routed between functional blocks within the FPGA. The [a:b] of Data[a:b] indicates a range of the number of lanes for the data lanes. The Valid lane is one of controls lanes and is for determining whether information flowing in the data lanes is valid. For the control lanes, Ready lane and the like may also be used. When the signal in the Valid lane (hereinafter Valid signal) is “1”, the edge control unit 206 recognizes the data in the data lane as information. The data is indicated by a hexagon.

When transmitting data to the partner computing machine, the edge control unit 206 of the computing machine 101-1 adds a control signal 401 with arrangement of multiple control patterns 403 into one clock immediately preceding the data. Accordingly, when transmitting data to the partner computing machine, the edge control unit 206 transmits a signal of two clocks or more. By contrast, in a communication scheme where data communication is not included in a control signal, such as Barrier, the edge control unit 206 transmits a control signal 402 with arrangement of multiple control patterns 403 to the partner computing machine. The edge control unit 206 transmits the control signal 402 to the partner computing machine with no information present before and after the control signal 402. The edge control unit 206 stands by during transmission of data and transmits the control signal 401 or the control signal 402 at a point when the transmission of the data has ended.

If the edge control unit 206 of the computing machine 101-1 finds no signal before or after a signal received from the partner computing machine and detects a signal of one clock, the edge control unit 206 receives that signal as the control signal 402. When it detects a continuous signal of two clocks or more, the edge control unit 206 sends the signal excluding the first one clock to the memory and switch 202 as data.

The edge control unit 206 therefore can determine whether a signal is a control signal or data from the continuity of the signal. Further, the edge control unit 206 does not require a function of recognizing the pattern of a control signal. Accordingly, the parallel computing machine system 2 can reduce a required circuit scale. Furthermore, the delay at the edge control unit 206 in reception of data is equivalent to one clock. Accordingly, the parallel computing machine system 2 can attain identification of a received signal with a slight delay.

Depending on the configuration of the computing machine 101-1, the Valid signal, which indicates whether information in the data lane at each clock is valid information, can be insufficient for determining the continuity of a signal. Accordingly, it is also necessary for the edge control unit 206 to know whether information in the data lane has been correctly received and data has been updated in the next clock. This information can be easily ascertained via exchange of handshake between the Valid signal and a signal in the Ready lane (hereinafter Ready signal), which are commonly used in ASICs and FPGAs. The control lanes in a bus within a chip of the computing machine 101-1 also include control lanes such as SOP (Start of Packet) and EOP (End of Packet) indicating start and end of information. Making use of them is also possible. This applies to a signal coming from another node in a network as well.

Here, the edge control unit 206 performs processing of (2) and (3) when using a communication scheme where only control signals are exchanged, such as Barrier. By contrast, when using a communication scheme where control signals and data are exchanged, such as SendRecv, the edge control unit 206 performs processing of (4) and (5).

(2) The edge control unit 206 has a function of transmitting a control signal in the case of communication where only control signals are exchanged. If the control management unit 207 of the computing machine 101-1 changes the register value for “communication information 301/Tx of the partner computing machine of the individual management 306” in the management register unit 204 from “0” to “1”, the edge control unit 206 that connects to the partner computing machine transmits a control signal to the partner computing machine. After the edge control unit 206 transmitted a control signal to the partner computing machine, the control management unit 207 changes the register value for the “completion state 302/Tx of the partner computing machine of the individual management 306” in the management register unit 204 from “0” to “1”.

(3) The edge control unit 206 has a function of receiving a control signal in the case of communication where only control signals are exchanged. The edge control unit 206 of the computing machine 101-1 detects a control signal of only one clock received from the partner computing machine. Then, if the register value for “communication information 301/Rx of the partner computing machine of the individual management 306” in the management register unit 204 is “1”, the edge control unit 206 changes the register value for the “completion state 302/Rx of the partner computing machine of the individual management 306” from “0” to “1”. If the “communication information 301/Rx of the partner computing machine of the individual management 306” is “0” on the other hand, the edge control unit 206 continues to stand by.

(4) The edge control unit 206 has a function of transmitting a control signal and data. The edge control unit 206 of the computing machine 101-1 takes no action after completion of data transmission to the partner computing machine. However, if the edge control unit 206 detects a control signal indicating a reception complete notification from the partner computing machine after data transmission to the partner computing machine, the control management unit 207 changes “completion state 302/Tx of the partner computing machine of the individual management 306” in the management register unit 204 from “0” to “1”. The control signal indicative of a reception complete notification (hereinafter reception complete notification) will be discussed later in function (5).

(5) The edge control unit 206 has a function of receiving a control signal and data. Upon receiving data from the partner computing machine, the edge control unit 206 of the computing machine 101-1 counts a data volume thereof. Then, the edge control unit 206 determines that the received data is information to be shared in parallel computation and sends it to the memory and switch 202. At the same time, the edge control unit 206 checks the “communication information 301/Rx of the partner computing machine of the individual management 306” in the management register unit 204 and “communication information 301/Size 305” in the management register unit 204. There are a case where the register value for the “communication information 301/Rx of the partner computing machine of the individual management 306” is “1” and a case where the register value for the “communication information 301/Size 305” agrees with the counted data size. In those cases, the edge control unit 206 changes the register value for the “completion state 302/Rx of the partner computing machine of the individual management 306” from “0” to “1”, considering that the reception from the partner computing machine is complete. Further, at a point in time when the FIFO 208 is emptied of stored data, the edge control unit 206 transmits a reception complete notification to the partner computing machine.

The control management unit 207 changes information in the communication information 301 of the management register unit 204 in response to an instruction from the arithmetic processing unit 201. Then, the control management unit 207 compares the register value for the “communication information 301/the individual management 306” with the register value for the “completion state 302/the individual management 306”. If the values completely agree with each other, namely, the communication between the computing machines is complete, the control management unit 207 notifies the arithmetic processing unit 201 about the completion of processing. Then, the control management unit 207 initializes the management register unit 204 and waits for the next instruction. Initializing indicates an operation to set all the register values to “0”. However, in rendezvous communication, which requires checking of setup of the receiving computing machine, the control management unit 207 performs control of reception confirmation and data communication separately. However, after the reception confirmation, no notification is made to the arithmetic processing unit 201 and only the “completion state 302/individual management 306” is initialized and the next control is executed.

The FIFO memory 208 is located between the edge control unit 206 and the memory and switch 202 and temporarily stores data exchanged between the edge control unit 206 and the memory and switch 202. The FIFO memory 208 is used in eager communication, for example. While the FIFO memory 208 is a feature that is originally present in the memory and switch 202, it is a component of the inter-computing machine control unit 203 in this example embodiment because checking of state is made during control between computing machines.

Next, operation of the computing machine 101-1 according to the second example embodiment is described. In the parallel computing machine system 2 according to the second example embodiment, the computing machine 101-1 to the computing machine 101-4 are connected in full mesh as shown in FIG. 2. For example, the computing machine 101-1 performs communication with the computing machine 101-1 to the computing machine 101-4 clearly separating data and control signals from each other. Accordingly, the computing machine 101-1 can achieve both control of and communication with the computing machine 1011 to the computing machine 101-4 with only one type of control signal through operations of the functional components provided therein. Here, each computing machine is made to execute a program that performs communication patterns (patterns P1 to P6).

The program executed on the computing machine 101-1 to the computing machine 101-4 is written with communication functions equivalent to MPI (Message Passing Interface), an interface used de fact in the parallel computing machine system 2. The arithmetic processing unit 201 of each computing machine gives instructions to the inter-computing machine control unit 203 to perform control and communication between computing machines during execution of a communication function in the program. Each computing machine operates on a similar algorithm.

The computing machine 101-1 to the computing machine 101-4 perform continuous communication with the following communication patterns in the parallel computing machine system 2. The names of communication functions in the patterns P2 to P6 are indicated by names with “MPI” dropped among the inter-computing machine communication functions defined by the MPI. For example, MPI Barrier is indicated by the name of Barrier.

Pattern P1: add a delay individually after summing up the times of the respective computing machines (the computing machine #1 500 nsec, the computing machine #2 1,000 nsec, the computing machine #3 0 nsec, and the computing machine #4 2,000 nsec)

Pattern P2: Barrier (all the computing machines)

Pattern P3: SendRecv (the computing machine #1 and the computing machine #2), eager communication

Pattern P4: SendRecv (the computing machine #1 and the computing machine #3), eager communication

Pattern P5: SendRecv (the computing machine #1 and the computing machine #3), eager communication

Pattern P6: Alltoall (all the computing machines), rendezvous communication

First, a reason for choosing these communication patterns is explained. What is important is whether communication is successfully performed without problems even when a difference in the time at which processing is started among the computing machine 101-1 to the computing machine 101-4 is larger than the delay in the links 102. An assumed delay of the links 102 is about 320 nsec. Thus, in the pattern P1, the delay that is added between the computing machine 101-1 to the computing machine 101-4 respectively was made larger than the assumed delay of the links 102.

If eager communication in which no check is made beforehand as to whether the partner computing machine is able to receive a signal or not (hereinafter reception confirmation) takes place successively, data drop can occur depending on a prepared buffer. Thus, conditions are most demanding when the same communication is successively performed. Accordingly, in the patterns P4 and P5, eager communications between the same computing machines are arranged successively.

Finally, rendezvous communication which requires prior reception confirmation, i.e., Alltoall, which is a complicated communication scheme using all the links 102 connected between the computing machine 101-1 to the computing machine 101-4, is performed in the last pattern P6.

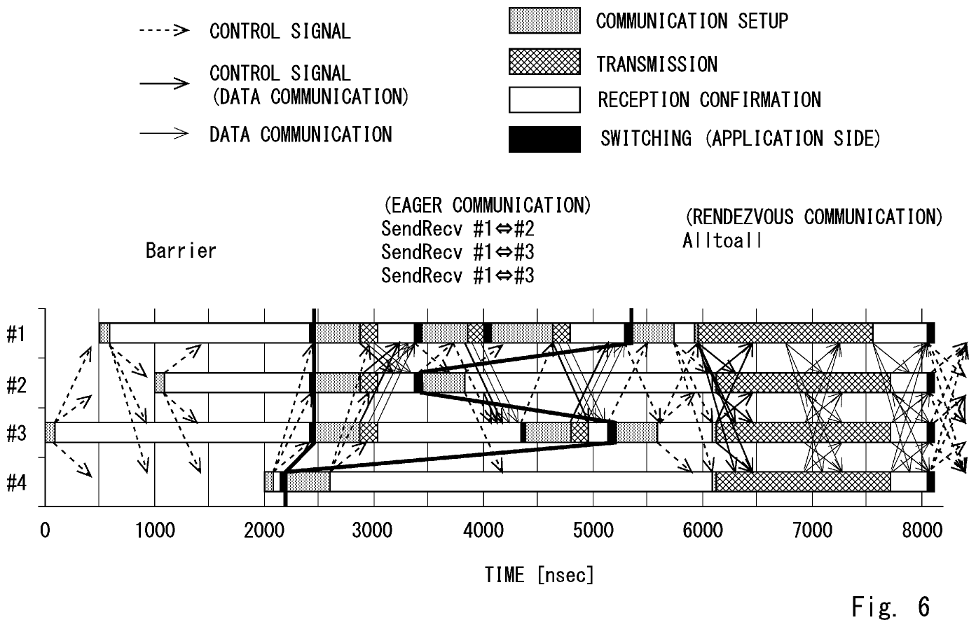

With reference to FIG. 6, an operational status of the arithmetic processing unit 201 of the computing machine 101-1 to the computing machine 101-4 with the patterns P2 to P6 in the parallel computing machine system 2 according to the second example embodiment is described. FIG. 6 is a process chart illustrating the operational status of the arithmetic processing unit 201 of each computing machine with the patterns P2 to P6 in the parallel computing machine system 2 according to the second example embodiment. The operation of the computing machine 101-1, which has high possibility of data dropout in succession of eager communication, will be mainly described. Operations of the computing machine 101-2 to the computing machine 101-4 will be referenced where description of only the computing machine 101-1 is not sufficient.

The states indicated by bars show operating states of the arithmetic processing unit 201. The operating states of the arithmetic processing unit 201 include four states: communication setup, transmission, reception confirmation and switching (application side). Here, a processing time of the arithmetic processing unit 201 in each of the operating states was measured by a time counter implemented on the FPGA circuit. Although the four operating states of the arithmetic processing unit 201 shown in FIG. 5 are related to transmission, they were also executed for reception in parallel. Communications between the computing machine 101-1 to the computing machine 101-4 are indicated by arrows. Exchange of only control signals is indicated by a black dotted line, a control signal added to data is indicated by a black solid line, and exchange of data is indicated by a gray solid line. The black dotted line and the black solid line are for the same control signal.

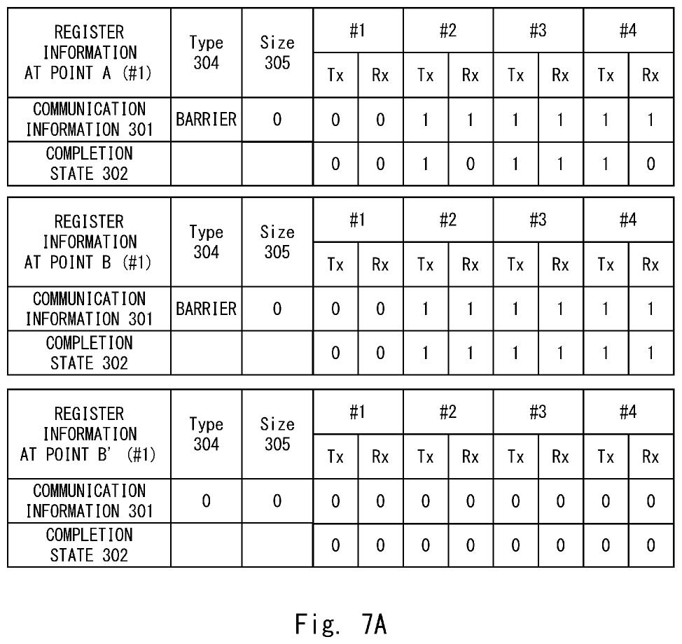

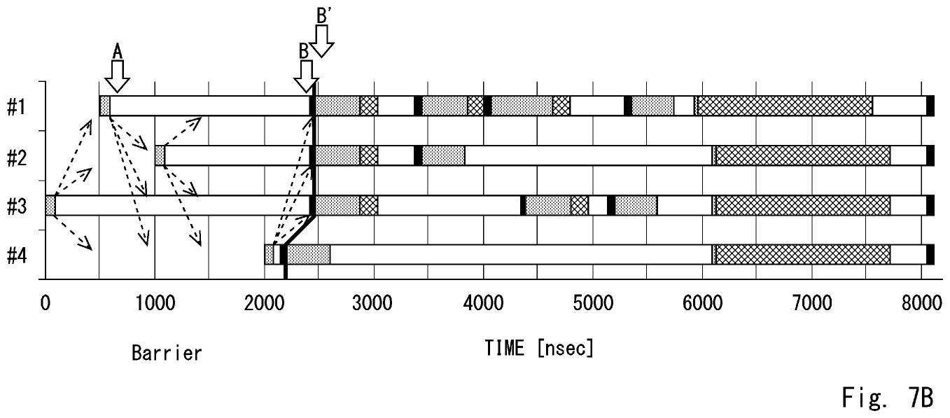

Next, with reference to FIGS. 7A and 7B, the operational status of the arithmetic processing unit 201 of the computing machine 101-1 to the computing machine 101-4 with the pattern P2 in the parallel computing machine system 2 according to the second example embodiment is described. FIG. 7A is a table showing register information in the management register unit 204 of each computing machine for the pattern P2 in the parallel computing machine system 2 according to the second example embodiment. FIG. 7B is a process chart illustrating the operational status of the arithmetic processing unit 201 of each computing machine with the pattern P2 in the parallel computing machine system 2 according to the second example embodiment.

First, the arithmetic processing unit 201 enters the communication setup state. Thereupon, the arithmetic processing unit 201 of the computing machine 101-1 performs communication setup for the computing machine 101-1 to the computing machine 101-4. If each computing machine uses Barrier as the communication scheme, the edge control unit 206 does not take data in/out of the memory and switch 202. Then, the arithmetic processing unit 201 immediately instructs the control management unit 207 to perform communication using Barrier. Subsequently, the control management unit 207 stores information related to Barrier in the “communication information 301/Type 304” of the management register unit 204. Then, in order to transmit control signals for Barrier to the computing machines 101-1 to 101-4, the control management unit 207 sets all of the “communication information 301/Tx of #2-#4 of the individual management 306” in the management register unit 204 to “1”. Meanwhile, the computing machine 101-2 to the computing machine 101-4 also each transmit a control signal to the computing machine 101-1. Accordingly, the control management unit 207 of the computing machine 101-1 sets all of the “communication information 301/Rx of #2-#4 of the individual management 306” to “1”. However, because the computing machine 101-1 does not perform transmission of a control signal to itself and reception of a control signal from itself, the “communication information 301/Tx and Rx of #1 of the individual management 306” remains “0”. Since the computing machine 101-1 does not transmit data to each computing machine in the case of using Barrier as the communication function, “communication information 301/Size 305” is “0”. Then, the control management unit 207 gives a notification to the arithmetic processing unit 201. The computing machine 101-1 may have a function of transmitting a control signal to itself.

Next, in response to the notification, the arithmetic processing unit 201 transitions to the transmission state. Now that the “communication information 301/Tx of #2-#4 of the individual management 306” in the management register unit 204 of the computing machine 101-1 has become “1”, the edge control unit 206 of the computing machine 101-1 transmits control signals to the computing machines 101-2 to 101-4. Then, at the same time as the transmission, the edge control unit 206 changes the register value for “completion state 302/Tx of #2-#4 of the individual management 306” in the management register unit 204 from “0” to “1”. Then, the control management unit 207 gives a notification to the arithmetic processing unit 201.

Next, in response to the notification, the arithmetic processing unit 201 transitions to a reception standby state. The edge control unit 206 of the computing machine 101-1 waits for reception of control signals from the computing machines 101-2 to 101-4. Then, the edge control unit 206 of the computing machine 101-1 receives control signals from the computing machines 101-2 to 101-4. Thereupon, the edge control unit 206 of the computing machine 101-1 checks the register value for “communication information 301/Rx of #2-#4 of the individual management 306” in the management register unit 204 and determines whether it is “1”.

For example, as shown in FIG. 7A, at a point immediately after the computing machine 101-1 transmitted control signals to the computing machines 101-2 to 101-4 (point A), the computing machine 101-1 has already received the control signal from the computing machine 101-3. As shown in FIG. 7B, at point A, the edge control unit 206 connected with the computing machine 101-3 changes the register value for the “completion state 302/Rx of the computing machine 101-3 of the individual management 306” in the management register unit 204 from “0” to “1”. However, the computing machine 101-1 has not received control signals from the computing machine 101-2 and the computing machine 101-4. Accordingly, the register values for the “completion state 302/Rx of #2 and #4 of the individual management 306” remain “0”. After point A, the computing machine 101-1 performs similar operations to those for the computing machine 101-3 with the computing machine 101-2 and the computing machine 101-4, too. Then, the control management unit 207 gives a notification to the arithmetic processing unit 201.

Next, in response to the notification, the arithmetic processing unit 201 transitions to the reception confirmation state. The control management unit 207 of the computing machine 101-1 always checks if the communication information 301 agrees with the information in the completion state 302 in the management register unit 204. Then, the edge control unit 206 of the computing machine 101-1 connected with the computing machine 101-4, which was activated last, receives a control signal and changes the register value for the “completion state 302/Rx of #4 of the individual management 306” from “0” to “1” (point B). At point B, the computing machine 101-1 has already received the control signal from the computing machine 101-2 as well. Accordingly, the control management unit 207 of the computing machine 101-1 determines that transmission and reception of control signals necessary for Barrier are complete at point B. The control management unit 207 notifies the arithmetic processing unit 201 of the completion and initializes the management register unit 204 (point B′). This initialized state represents the state of waiting for the next instruction. The control management unit 207 gives a notification to the arithmetic processing unit 201. In response to the notification, the arithmetic processing unit 201 transitions to a state of switching to the next pattern P3 (an application).

Exchange of control between computing machines strongly depends on the operation of the computing machine that starts processing the latest. As a comparative example, after control is started at the computing machine that starts processing the latest, the computing machines may share control signals after going through multiple communications in the worst case (generally Log₂N communications, N being the number of computing machines). By contrast, the computing machine 101-1 is able to complete Barrier only by a single exchange of control signals (point B). The computing machine 101-1 therefore can increase the effect of reduced delay as the number of the partner computing machines it connects increases.

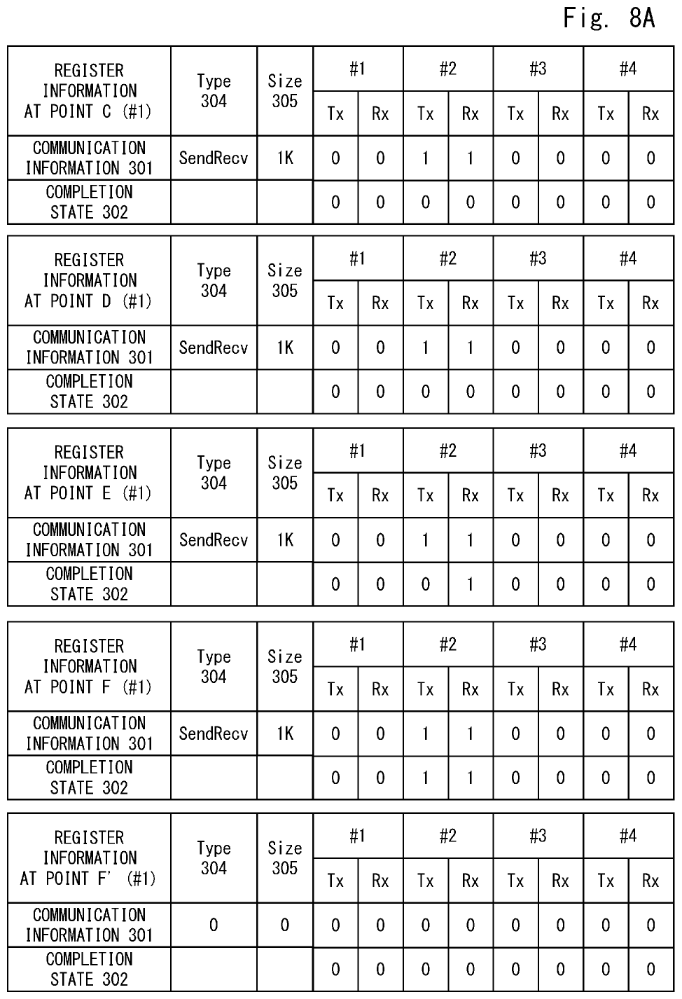

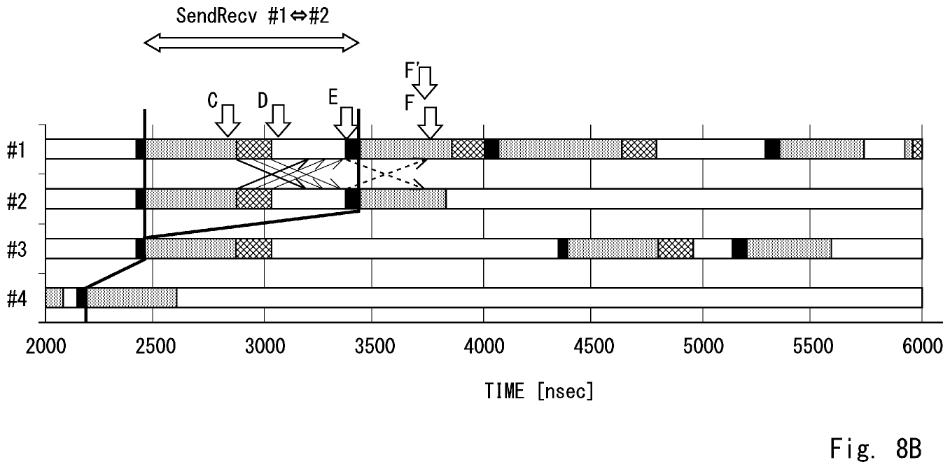

Next, referring to FIGS. 8A and 8B, the operational status of the arithmetic processing unit 201 of the computing machine 101-1 to the computing machine 101-4 with the pattern P3 in the parallel computing machine system 2 according to the second example embodiment is described. FIG. 8A is a table showing register information in the management register unit 204 of the computing machine 101-1 for the pattern P3 in the parallel computing machine system 2 according to the second example embodiment. FIG. 8B is a process chart illustrating the operational status of the arithmetic processing unit 201 of each computing machine with the pattern P3 in the parallel computing machine system 2 according to the second example embodiment. SendRecv is a one-to-one communication function, capable of giving instructions on bi-directional communication. Here, the computing machine 101-1 has performed data communication of 1 kB, equivalent to a reception buffer for eager communication, with the computing machine 101-2.

On the computing machines 101-1 and 101-2, the arithmetic processing unit 201 transitions to the communication setup state for the pattern P3 after detecting the end of the pattern P2. The arithmetic processing unit 201 gives the control management unit 207 an instruction to start communication in the pattern P3 during the communication setup state. Then, the control management unit 207 changes the communication information 301 in the management register unit 204 (point C). As shown in FIG. 8A, at point C, the register value for the “communication information 301/Tx of #2 of the individual management 306” in the management register unit 204 on the computing machine 101-1 has been changed from “0” to “1”.

In the computing machine 101 according to the second example embodiment, before data arrives at the edge control unit 206 from the memory and switch 202, the arithmetic processing unit 201 gives an instruction to the control management unit 207. The edge control unit 206 has a circuit that adds a control signal to the beginning data regardless of the state of the management register unit 204. Accordingly, the edge control unit 206 can safely receive an instruction from the arithmetic processing unit 201 during transmission or reception of data.

Thereafter, the computing machine 101-1 transmits all the data to the computing machine 101-2. Point D is a point after the computing machine 101-1 transmitted all the data to the computing machine 101-2. However, at point D, the management register unit 204 remains in the same state as at point C.

As time further passes, the computing machine 101-1 receives data from the computing machine 101-2. The edge control unit 206 which connects to the computing machine 101-2 removes the control signal at the beginning of information being continuously received and passes data to the memory and switch 202. Further, the edge control unit 206 keeps count of the data volume and compares the data volume with the register value for the “communication information 301/Size 305” in the management register unit 204. If the data volume agrees with it and the reception is complete, the edge control unit 206 changes the register value for the “completion state 302/Rx of #2 of the individual management 306” in the management register unit 204 from “0” to “1” (point E). At almost the same time as point E, the edge control unit 206 checks for availability in the FIFO 208 for eager communication. Upon checking that there is availability, the edge control unit 206 transmits a control signal to the computing machine 101-2 as a reception complete notification.

This example embodiment additionally includes a function by which the control management unit 207 notifies the arithmetic processing unit 201 after recognizing the control signal as a reception complete notification. Thus, the arithmetic processing unit 201 can execute the next computation instantaneously using the received data.

Similar operations have also taken place in the computing machine 101-2 and a control signal as a reception complete notification is sent from the computing machine 101-2 as well. At the computing machine 101-1, the edge control unit 206 connected with the computing machine 101-2 receives the arriving control signal (point F). At point F, the edge control unit 206 changes the register value for “completion state 302/Tx of #2 of the individual management 306” in the management register unit 204 from “0” to “1”.

Thus, at point F, the register value for “communication information 301/#2 of the individual management 306” and the register value for “completion state 302/#2 of the individual management 306” agree with each other. After detecting the agreement, the control management unit 207 determines that pattern #3 has finished, notifies the arithmetic processing unit 201 of it and initializes the management register unit 204 (point F′).

A way of counting the data volume in the edge control unit 206 as mentioned above in point E is described. The number of data lanes in a computing machine is predetermined, with the data volume per clock being the same as the number of lanes. Accordingly, the data volume=the number of clocks×the number of lanes. The data volume was estimated with a simple feature for counting such clocks. Depending on the way of calculation, data can exist only in some of the data lanes. In that case, however, information on the same is present in control lanes flowing in parallel, so that a circuit for estimating the data volume based on the information may be prepared.

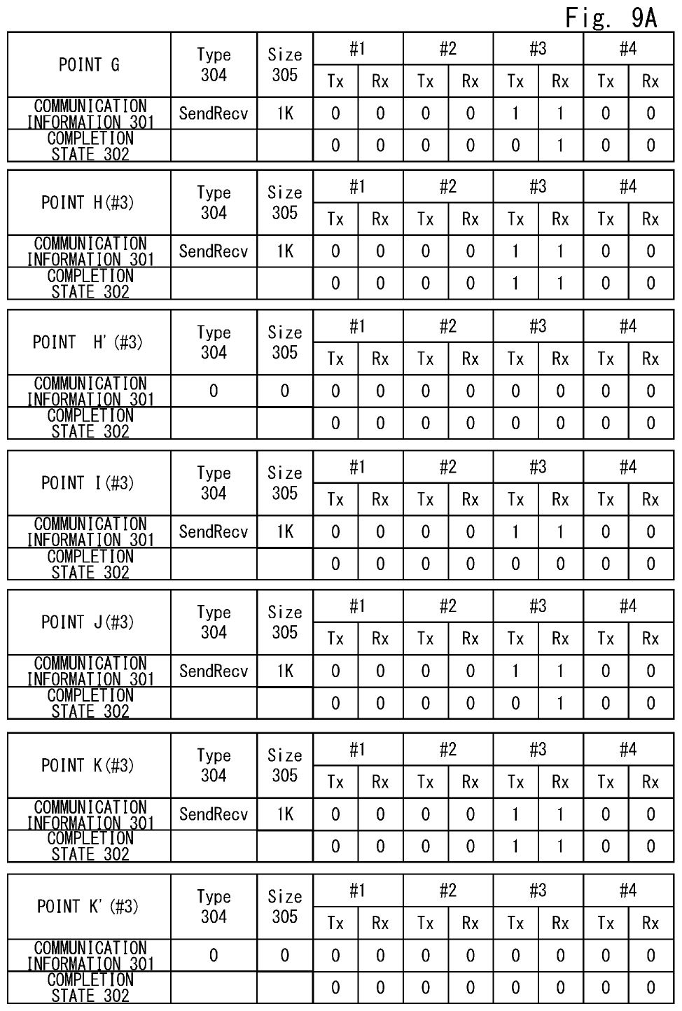

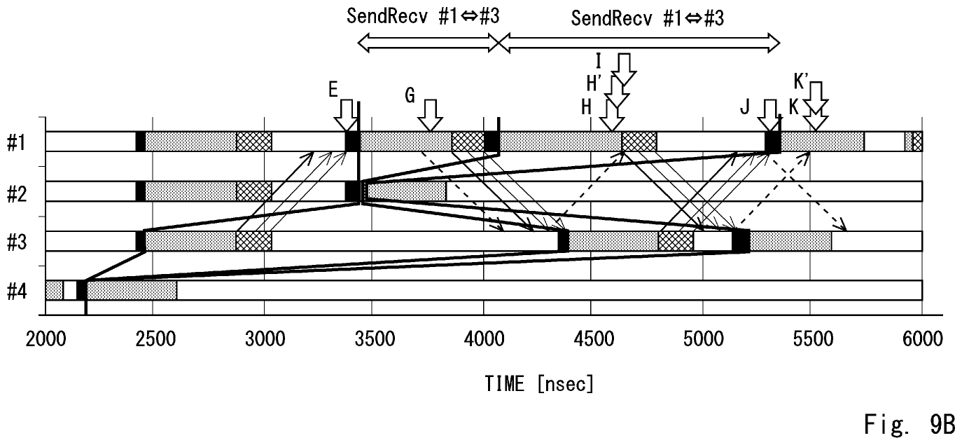

Next, referring to FIGS. 9A and 9B, the operational status of the arithmetic processing unit 201 of the computing machine 101-1 to the computing machine 101-4 with the patterns P4 and P5 in the parallel computing machine system 2 according to the second example embodiment is described. FIG. 9A is a table showing register information in the management register unit 204 of the computing machine 101-1 for the patterns P4 and P5 in the parallel computing machine system 2 according to the second example embodiment. FIG. 9B is a process chart illustrating the operational status of the arithmetic processing unit 201 of each computing machine with the patterns P4 and P5 in the parallel computing machine system 2 according to the second example embodiment.

Succession of eager communications between the same computing machines tends to cause data loss with data reception above the reception buffer. The computing machine 101-3, which is irrelevant to communication in the pattern P3, starts communication in the pattern P4 after the pattern P2. Accordingly, the computing machine 101-1 has already received data from the computing machine 101-3 at point E. However, the FIFO 208 of the computing machine 101-1 still stores the data from the computing machine 101-3. In addition, the edge control unit 206 which connects to the computing machine 101-3 is also on standby still saving the data size received from the computing machine 101-3. Accordingly, at point E, the register value for the “communication information 301/Rx of #3 of the individual management 306” in the management register unit 204 of the computing machine 101-1 is “0”.

Subsequently, on the computing machine 101-1, the arithmetic processing unit 201 instructs the control management unit 207 on communication in the pattern P4 (point G). At point G, the edge control unit 206 of the computing machine 101-1 starts receiving data from the computing machine 101-3. Point G is subsequent to point F′, at which processing for the pattern P3 was complete and the control management unit 207 of the computing machine 101-1 performed processing for initialization of the management register unit 204. Then, the edge control unit 206 at the computing machine 101-1 which connects with the computing machine 101-3 checks the “communication information 301/Size 305” in the management register unit 204 and recognizes that 1 k of data is received from the computing machine 101-3. As the 1 k of data is already received, the edge control unit 206 of the computing machine 101-1 instantaneously changes the register value for the “completion state 302/Rx of #3 of the individual management 306” in the management register unit 204 from “0” to “1”. At the same time, the edge control unit 206 of the computing machine 101-1 confirms that all the data has moved from the connected FIFO 208 to the memory and switch 202 and sends a control signal to the computing machine 101-3 as a reception complete notification. In this manner, this example embodiment allows short data to be received with no data loss and with low delay even during execution of other communication.

Subsequently, in the pattern P5 as in the pattern P4, the edge control unit 206 of the computing machine 101-1 transmits data to the computing machine 101-3. Depending on the timing of instruction from the arithmetic processing unit 201, the edge control unit 206 of the computing machine 101-1 may transmit data to the computing machine 101-3 before reception of data from the computing machine 101-3. In such a case, the edge control unit 206 of the computing machine 101-1 is configured to transmit a control signal as reception complete notification to the computing machine 101-3 after completion of data transmission to the computing machine 101-3. Specifically, the edge control unit 206 of the computing machine 101-1 sends a control signal as reception complete notification one clock after the completion of data transmission to the computing machine 101-3. An increase in the amount of delay associated with this difference in operation of the computing machine 101-1 is negligible.

Subsequently, upon receiving the control signal as a reception complete notification from the computing machine 101-3, the edge control unit 206 of the computing machine 101-1 changes the register value for “completion state 302/Tx of #3 of the individual management 306” in the management register unit 204 from “0” to “1” (point H). Subsequently, the control management unit 207 of the computing machine 101-1 determines that SendRecv has been normally completed based on information in the management register unit 204 and notifies the arithmetic processing unit 201 of the same. At the same time, the control management unit 207 of the computing machine 101-1 initializes the register value of the management register unit 204 (point H′).

Then, the arithmetic processing unit 201 of the computing machine 101-1 gives an instruction on communication in the next pattern P5 to the control management unit 207. Along with it, the arithmetic processing unit 201 gives an instruction to the memory and switch 202. It causes the memory and switch 202 to transmit data to the edge control unit 206 connected with the computing machine 101-3. The edge control unit 206 transmits the data to the computing machine 101-3 (point I).

Subsequently, upon having received all the data from the computing machine 101-3, the edge control unit 206 of the computing machine 101-1 changes the register value for the “completion state 302/Rx of #3 of the individual management 306” in the management register unit 204 from “0” to “1” and sends a control signal as reception complete notification to the computing machine 101-3 (point J). Then, the edge control unit 206 of the computing machine 101-1 changes the register value for “completion state 302/Tx of #3 of the individual management 306” from “0” to “1” in response to the reception complete notification from the computing machine 101-3 (point K). Subsequently, it detects the completion of the communication in the pattern P5 and notifies the arithmetic processing unit 201 of the same. The control management unit 207 initializes the register value of the management register unit 204 (point K′).

Therefore, in the pattern P5, the computing machine 101-1 waits for the reception complete notification for the previous communication from the computing machine 101-3 when transmitting data to the computing machine 101-3. However, the computing machine 101-1 is able to carry out communication without data loss even if eager communication takes place successively. The computing machine 101-1 can also perform setup of the memory and switch 202 in parallel while waiting for the reception complete notification from the computing machine 101-3. Accordingly, the computing machine 101-1 can minimize an increase in delay associated with waiting for a reception complete notification.

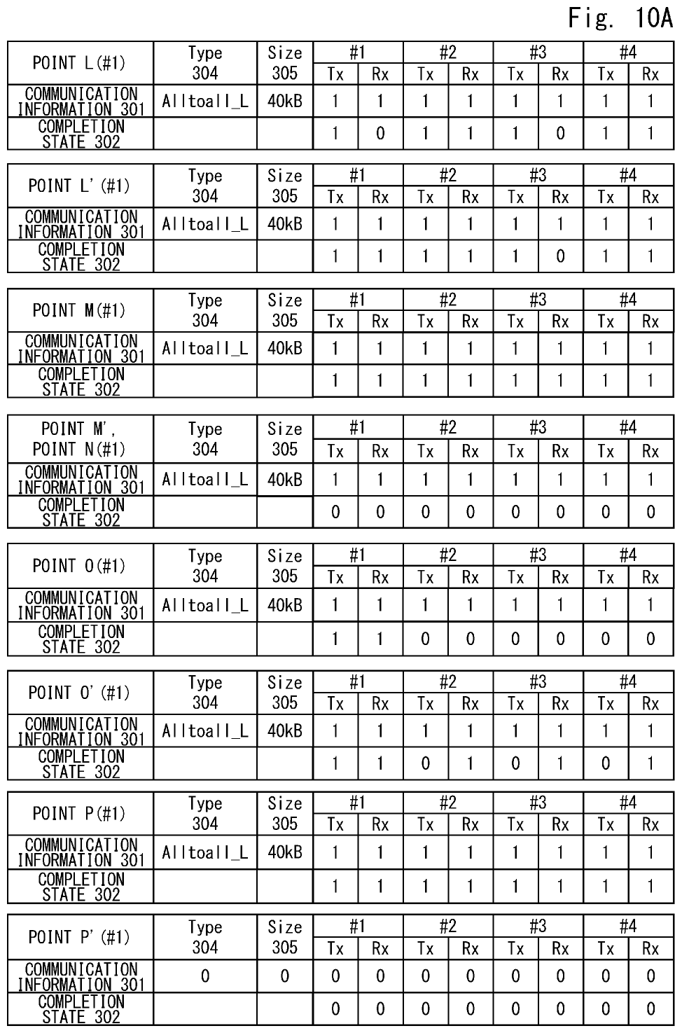

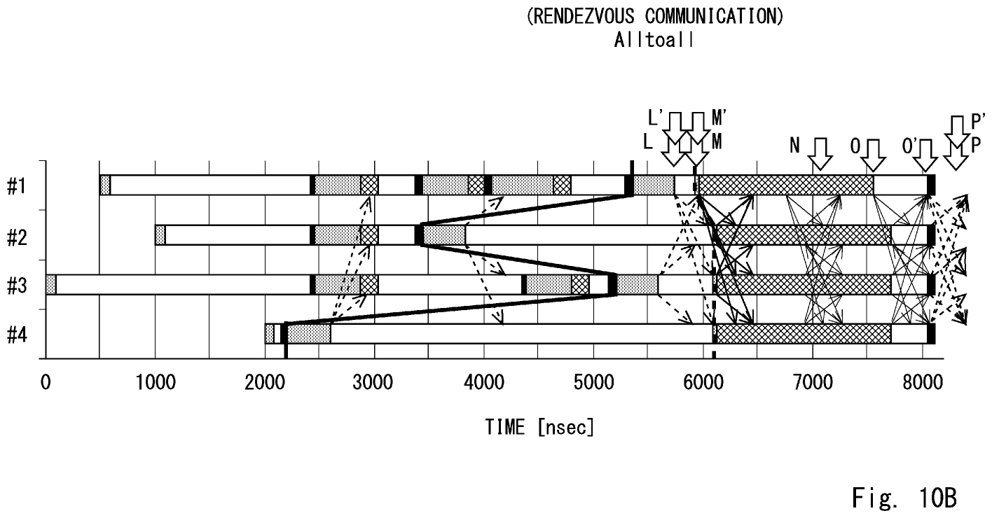

Next, referring to FIGS. 10A and 10B, an operational status of the arithmetic processing unit 201 of the computing machine 101-1 to the computing machine 101-4 with the pattern P6 in the parallel computing machine system 2 according to the second example embodiment is described. FIG. 10A is a table showing register information in the management register unit 204 of the computing machine 101-1 for the pattern P6 in the parallel computing machine system 2 according to the second example embodiment. FIG. 10B is a process chart illustrating the operational status of the arithmetic processing unit 201 of each computing machine with the pattern P6 in the parallel computing machine system 2 according to the second example embodiment.

The arithmetic processing unit 201 of each computing machine gives an instruction to the control management unit 207 at a point when the memory and switch 202 ends reception setup. The control management unit 207 rewrites the communication information 301 of the management register unit 204. For example, in collective communication like Alltoall, the computing machine 101-1 also includes communication with its own node, namely, the computing machine 101-1. Accordingly, the control management unit 207 sets the register value for “communication information 301/Tx and Rx of #1 of the individual management 306” in the management register unit 204 to “1”. Based on this information, the edge control unit 206 transmits control signals to the computing machines 101-1 to 101-4 (point L). The computing machine 101-2 to the computing machine 101-4 also perform similar operations to that of the computing machine 101-1.

When the computing machine 101-1 transmits a control signal to itself, it receives the control signal in several clocks. Accordingly, the computing machine 101-1 instantaneously sets the register value for “completion state 302/Rx of #1 of the individual management 306” in the management register unit 204 to “1” (point L′).

As a result of performing communications in the patterns P1 to P5, a difference in the time at which the arithmetic processing unit 201 starts the pattern P6 occurs among the computing machine 101-1 to the computing machine 101-4. Giving an example where the time difference is the maximum, a difference of about 3,000 nsec exists between the time at which the computing machine 101-1 starts the pattern P6 and the time at which the computing machine 101-4 starts the pattern P6. Due to this large time difference, the computing machine 101-1, which starts the pattern P6 subsequent to the computing machine 101-2 and the computing machine 101-4, receives control signals from the computing machine 101-2 and the computing machine 101-4 while performing other communication. However, the computing machine 101-1 stands by while holding the received state.

Subsequently, after receiving the control signal from the computing machine 101-3, the edge control unit 206 of the computing machine 101-1 changes the register value for the “completion state 302/Rx of #2 of the individual management 306” in the management register unit 204 from “0” to “1” (point M).

At point M, the register value for the “communication information 301/the individual management 306” and the register value for the “completion state 302/the individual management 306” agree with each other. Accordingly, the control management unit 207 of the computing machine 101-1 notifies the arithmetic processing unit 201 of this completion of reception confirmation and initializes the register value for the “completion state 302/the individual management 306” (point M′).

The arithmetic processing unit 201 of the computing machine 101-1 starts transmission of data based on the notification of the completion of reception confirmation. The edge control unit 206 of the computing machine 101-1 adds a control signal to the beginning of data being transmitted. The edge control unit 206 also removes the head of received data, namely, the control signal, and then passes the data to the memory and switch 202 (point N).

Subsequently, the edge control unit 206 of the computing machine 101-1 ends transmission of all data to the computing machines 101-1 to 101-4. Here, a delay in the links 102 does not occur in communication to itself. Accordingly, the edge control unit 206 of the computing machine 101-1 changes the register values for the “completion state 302/Tx and Rx of #1 of the individual management 306” in the management register unit 204 from “0” to “1” (point O).

Then, the edge control unit 206 of the computing machine 101-1 receives data from the computing machines 101-2 to 101-4. Thereupon, if it receives data from the computing machine 101-2, for example, the edge control unit 206 of the computing machine 101-1 changes the register value for “completion state 302/Rx of #2 of the individual management 306” in the management register unit 204 from “0” to “1”. Subsequently, the edge control unit 206 of the computing machine 101-1 checks that no data is present in the FIFO 208 and then sends a control signal as reception complete notification to the computing machine 101-2. The edge control unit 206 of the computing machine 101-1 also performs similar operations when receiving data from the computing machine 101-3 and the computing machine 101-4 (point O′).

Finally, the edge control unit 206 of the computing machine 101-1 receives control signals as reception complete notification from the computing machines 101-2 to 101-4. Thereupon, if it receives a control signal from the computing machine 101-2, for example, the edge control unit 206 of the computing machine 101-1 changes the register value for “completion state 302/Tx of #2 of the individual management 306” in the management register unit 204 from “0” to “1”. The edge control unit 206 of the computing machine 101-1 also performs similar operations when receiving control signals from the computing machine 101-3 and the computing machine 101-4 (point P).

At point P, the register value for the “communication information 301/individual management 306” and the register value for the “completion state 302/individual management 306” in the management register unit 204 agree with each other. Accordingly, the control management unit 207 of the computing machine 101-1 notifies the arithmetic processing unit 201 of completion of Alltoall as rendezvous communication and initializes the register value for the “completion state 302/the individual management 306” in the management register unit 204 (point O′).

Therefore, the computing machine 101-1 can carry out communication with low delay and with almost no increase in delay associated with control only via a single control signal.

If resource such as an SRAM on the chip has room, information on communication can be added to the control signal. It allows the arithmetic processing unit 201 or the control management unit 207 to check the content of an instruction on communication between computing machines during subsequent data communication and the like, while achieving low delay with a simple way of sorting a signal into a control signal and data based on difference in clocks. This can provide more reliable communication, such as allowing an error in case there is a mistake in a program to be checked at an earlier stage. For a program that is reliably operable, however, this example embodiment is desirable for exerting arithmetic performance as parallel computing machines.

The computing machine 101-1 according to the second example embodiment therefore can minimize resource for control between multiple computing machines. Specifically, the computing machine 101-1 uses as minimum as one type of control signal. Further, the computing machine 101-1 does not use pattern recognition of multiple complicated signals. Thus, the computing machine 101-1 can minimize the quantity of registers for managing the network.

The computing machine 101-1 can also minimize a delay involved in control between computing machines. Specifically, the computing machine 101-1 realizes communication between the fully connected computing machines in a simple control scheme. Thus, the computing machine 101-1 not only reduces the number of communications required for control by full connection to one but enables separation of data and a control signal only by determining the number of clocks of a control signal and allows instantaneous grasping of states between computing machines.

### Third Example Embodiment

A parallel computing machine system 3 according to the third example embodiment includes a computing machine 501-1, a computing machine 501-2, a computing machine 501-3 and a computing machine 501-4. The computing machine 501-1 in the parallel computing machine system 3 according to the third example embodiment has a similar configuration to that of the computing machine 101-1 in the parallel computing machine system 2 according to the second example embodiment. The computing machine 501-1 uses different methods of transmitting and receiving signals compared to the computing machine 101-1.

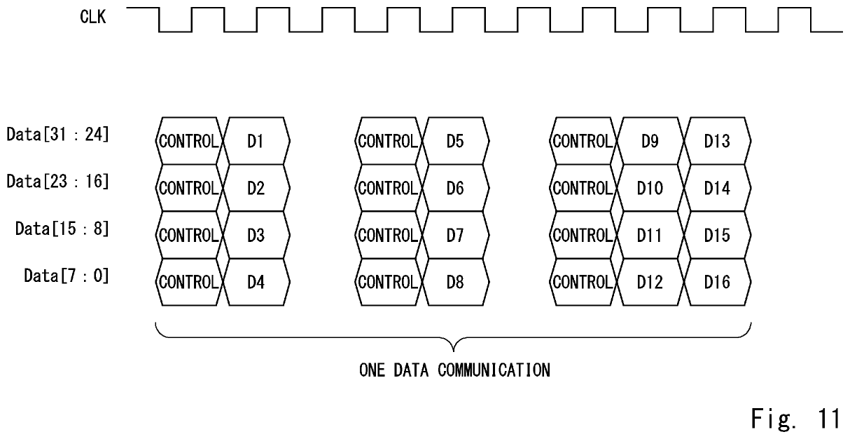

With the computing machine 101-1 according to the second example embodiment, band degradation poses a problem if data is interrupted due to some issue in signals being transmitted. Referring to FIG. 11, band degradation in signals transmitted by the computing machine 101-1 according to the second example embodiment is described. FIG. 11 is a timing chart showing band degradation in signals transmitted by the computing machine 101-1 according to the second example embodiment. As shown in FIG. 11, when the edge control unit 206 of the computing machine 101-1 transmits data D1 to D16, a control signal+a space of one clock is added to each interrupted data. Thus, band degrades by the amount of this addition. This interruption of data can occur such as when memory addresses are not consecutive.

Accordingly, the edge control unit 206 of the computing machine 501-1 has a function of counting data. Also, the memory and switch 202 does not input data to the edge control unit 206 until the control management unit 207 sets a communication instruction entailing data communication in the management register unit 204. These features are effected by the READY signal in the control lane being turned off.

Further, the edge control unit 206 includes information on data size into the control signal and transmits the control signal and data to the partner computing machine. The data size is the register value for “communication information 301/Size 305” in the management register unit 204. The edge control unit 206 does not add the control signal and transmits data to the partner computing machine as it is until the data counter becomes the data size.

In contrast, when the edge control unit 206 receives data with a control signal from the partner computing machine, it extracts information on the data size from the control signal. The edge control unit 206 determines completion of reception of data from the partner computing machine based on the data size volume extracted from the control signal. Specifically, if the data count value agrees with the data size contained in the control signal at reception of data, the edge control unit 206 determines that reception of data from the other computing machine is complete.

Here, from when a control signal for data communication is first received to when the reception of data is completed, the edge control unit 206 also counts the signal for the first one clock as data and transmits that data to the memory and switch 202.

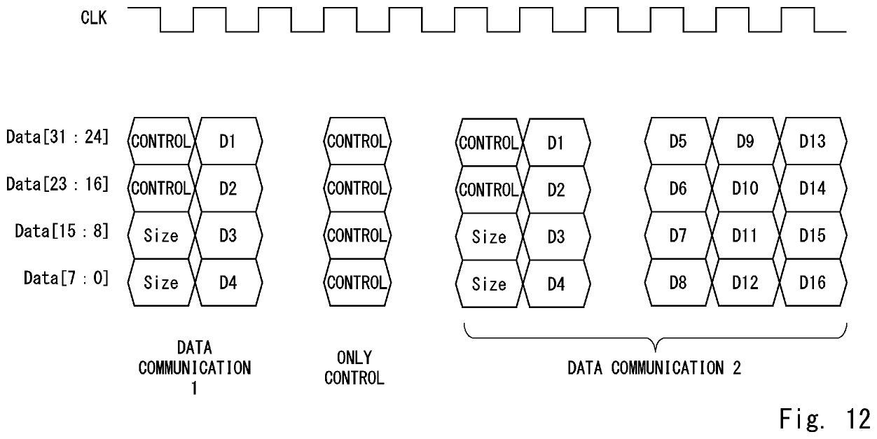

Due to the provision of these functions in the computing machine 501-1 according to the third example embodiment, a signal transmitted by the edge control unit 206 to the partner computing machine is such as shown in FIG. 12. FIG. 12 is a timing chart of signals which are transmitted to the partner computing machine by the edge control unit 206 according to the third example embodiment.

Therefore, the computing machine 501-1 according to the third example embodiment can suppress excessive degradation of band when data does not appear continuously. The edge control unit 206 can extract information on the data size contained in the control signal. Accordingly, the edge control unit 206 can carry out efficient communication such as shown in FIG. 12 even when there is a large time difference occurring among computing machines. The edge control unit 206 can further verify whether data received from the partner computing machine conforms to the content of a transmitted communication instruction based on information on the data size added to the control signal. Thus, the computing machine 501-1 attains reliable communication.

The computing machine 501-1 according to the third example embodiment also transmits a control signal containing information on the data size to the partner computing machine. Thus, the computing machine 501-1 enables data reception with low delay even when the data size to be received cannot be determined from a program.

### Fourth Example Embodiment

A parallel computing machine system 4 according to a fourth example embodiment includes a computing machine 601-1, a computing machine 601-2, a computing machine 601-3 and a computing machine 601-4. The computing machine 601-1 attains fast control between computing machines with an application that uses a great deal of one-way communication (such as Send function and Recv function, Scatter function, Gather function).

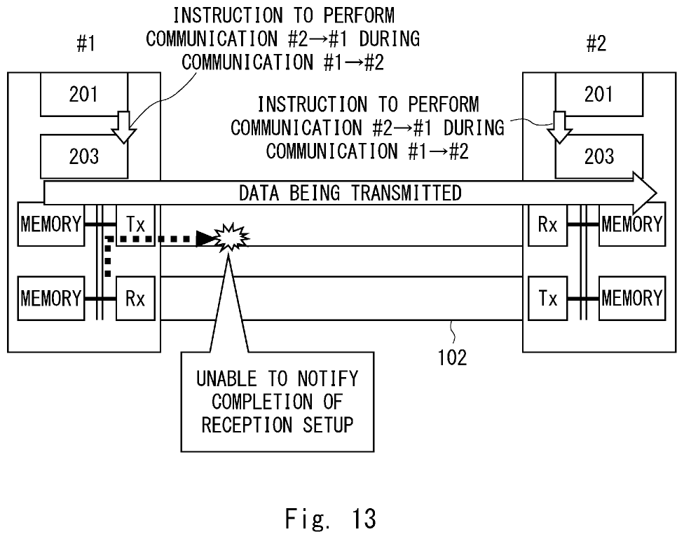

Referring to FIG. 13, an issue is described which can occur in an application that uses a great deal of one-way communication in the case of using the parallel computing machine system 1 according to the first example embodiment, the parallel computing machine system 2 according to the second example embodiment and the parallel computing machine system 3 according to the third example embodiment. FIG. 13 is a schematic diagram showing an issue that can occur in an application that uses a great deal of one-way communication in the parallel computing machine system 2 according to the second example embodiment. Here, it is described by taking communication between the computing machine 101-1 (#1) and the computing machine 101-2 (#2) in the parallel computing machine system 2 according to the second example embodiment as an example. This issue is a case where during transmission of bulk data from the computing machine 101-1 to the computing machine 101-2, the arithmetic processing unit 201 of the computing machine 101-2 instructs the computing machine 101-1 to perform communication in the reverse direction (from the computing machine 101-2 to the computing machine 101-1).

As the receiving side (hereinafter Rx) of the computing machine 101-1 is available for reception, normally it is desirable to immediately transmit a reception setup complete notification to the computing machine 101-2. However, because the transmitting side (hereinafter Tx) of the computing machine 101-1 is transmitting data, it cannot transmit a reception setup complete notification to the computing machine 101-2 until the data transmission ends. Accordingly, the efficiency of parallel processing decreases.

Thus, in order that two one-way communications can be managed simultaneously between computing machines, the management register unit 204 of the computing machine 601-1 in the parallel computing machine system 4 according to the fourth example embodiment is configured with two sets of combinations of the communication information 301 and the completion state 302. The control management unit 207 of the computing machine 601-1 has a function of permitting writing of information to the communication information 301 if Tx and Rx which are selected in the respective individual management 306 of the communication information 301 in the management register unit 204 do not overlap.

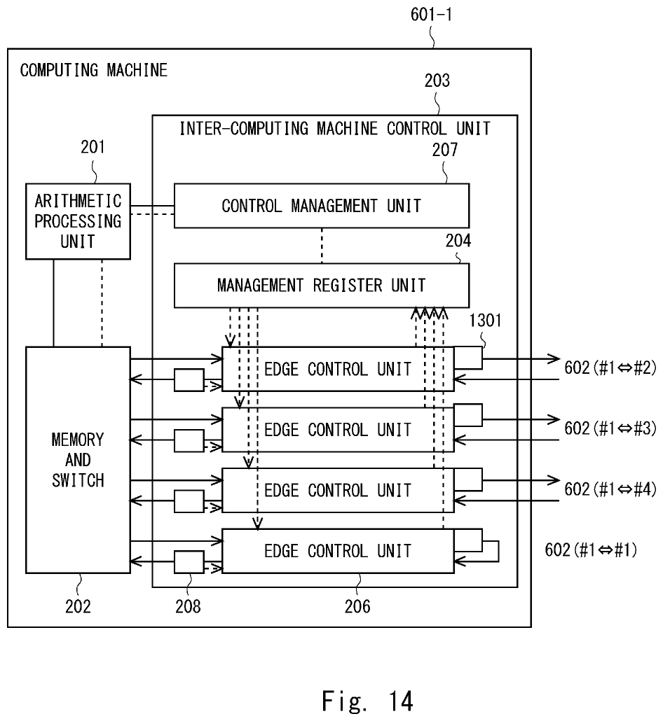

Next, as shown in FIG. 14, the computing machine 601-1 according to the fourth example embodiment is configured such that a function of counting data volume is added to the computing machine 101-1 on the transmitting side of the edge control unit 206. FIG. 14 is a block diagram showing a configuration of the computing machine 601-1 according to the fourth example embodiment. The computing machine 601-1 is configured such that a function of adding data size to a control signal being added at the beginning of data and a function of recognizing the data size on the receiving side are added to the computing machine 101-1. Further, the computing machine 601-1 is also configured such that a function of not adding a control signal if data from the memory and switch 202 is interrupted is added to 101-1. However, unlike the computing machine 501-1 according to the third example embodiment, the computing machine 601-1 is configured with addition of a dedicated FIFO unit 1301 which outputs data of at least two clocks when data is output to links 602 side of the edge control unit 206. The FIFO unit 1301 further has a function of putting data on standby also when the remaining data to be transmitted is equivalent to one clock and transmitting data together. If an instruction on communication in the reverse direction is given during data communication for one-way communication, the FIFO unit 1301 once stops the transmission in the data communication, transmit a control signal of one clock, and then performs subsequent data transmission after one clock.

Then, if a signal of one clock arrives during data reception, the edge control unit 206 recognizes it as a control signal and sets the register value for the corresponding “completion state 302/Rx of the partner computing machine of the individual management 306” from “0” to “1”.

In this example embodiment, the computing machine 601-1 according to the fourth example embodiment requires twice as much information in the management register unit 204. However, the computing machine 601-1 enables management of communication by simple determination, like the computing machine 101-1 and the computing machine 501-1. Moreover, the computing machine 601-1 can attain bi-directional communication with low delay even when there is an instruction on communication in another direction.

### Fifth Example Embodiment

A parallel computing machine system 5 according to a fifth example embodiment includes a computing machine 701-1, a computing machine 701-2, a computing machine 701-3 and a computing machine 701-4. In the parallel computing machine system 5, if some issue occurs on a computing machine and parallel computation can no longer be executed, it is desirable to notify the other computing machines of an error signal. By interrupting computation upon receiving the error signal, a wasted parallel computation time can be stopped early.

Sending of such an error signal is, however, not explicitly shown in the program running on each computing machine. The computing machine 11 according to the first example embodiment, the computing machine 101-1 according to the second example embodiment, the computing machine 501-1 according to the third example embodiment and the computing machine 601-1 according to the fourth example embodiment cannot handle an irregularly occurring error.

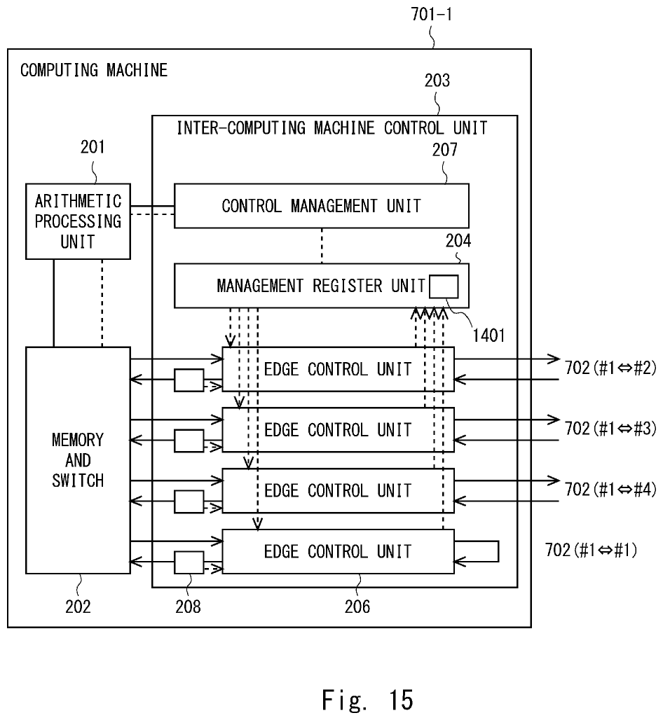

As shown in FIG. 15, the computing machine 701-1 according to the fifth example embodiment is configured such that an error register 1401 is added to the management register unit 204 of the computing machine 101-1 according to the second example embodiment. FIG. 15 is a block diagram showing a configuration of the computing machine 701-1 according to the fifth example embodiment. The error register 1401 normally contains “0” in its register value as a state with no error. The error register 1401 changes its register value from “0” to “1” in two cases: where an error occurs in the computing machine 701-1 and where an error notification is received from the partner computing machine.

First, the operation of the computing machine 701-1 in the case where an error occurs in the computing machine 701-1 is described. If an error occurs in the computing machine 701-1 somewhere other than the inter-computing machine control unit 203, the control management unit 207 changes the register value of the error register 1401 from “0” to “1” according to an instruction from the arithmetic processing unit 201. In contrast, if the edge control unit 206 has failed to transmit or receive an amount of information necessary for communication within a certain period of time, the edge control unit 206 changes the register value of the error register 1401 from “0” to “1”.

Further, when the control management unit 207 or the edge control unit 206 has changed the register value of the error register 1401 from “0” to “1, the edge control unit 206 notifies all the connected computing machines of a control signal twice successively as error notification. The reason for the number of successions being two is that a number greater than the number of communications handled by the management register unit 204 is necessary. With only twice, the control signal cannot be distinguished from communication that can be possibly handled by the management register unit 204. Accordingly, if the error register 1401 is included in the computing machine 601-1 according to the fourth example embodiment, the number of successions will be three.

Next, the operation of the computing machine 701-1 in the case where an error occurs in the partner computing machine is described. The edge control unit 206 changes the register value of the error register 1401 from “0” to “1” when it receives control signals equal to or more than the number of communications handled by the management register unit 204. Then, the control management unit 207 periodically checks the value of the error register. When the register value of the error register 1401 is “1”, the control management unit 207 notifies the arithmetic processing unit 201 of an error. In response, the arithmetic processing unit 201 stops computation. The arithmetic processing unit 201 may periodically check the register value of the error register 1401 via the control management unit 207.

Therefore, the computing machine 701-1 according to the fifth example embodiment can attain error notification as well as communication between computing machines still with one type of one-clock control signal. Then, the computing machine 701 no longer continues unnecessary computations while remaining in an error state and can attain a more efficient parallel computing machine system with a low amount of resource.

The present disclosure is not limited to the example embodiments described above but can be modified where appropriate within the scope of the present disclosure.

The components in the example embodiments above consist of hardware, software, or both of them; they may consist of one piece of hardware or software or of multiple pieces of hardware or software. Functions (processing) of each device may be embodied by a computer with a CPU, memory and the like. For example, a program for performing a method according to an example embodiment may be stored in a storage device and functions may be embodied by executing the program stored in the storage device in the CPU.

Such programs can be stored on various types of non-transitory computer-readable media and supplied to a computer. Non-transitory computer-readable media include various types of tangible storage media. Examples of non-transitory computer-readable media include magnetic storage media (e.g., flexible disk, magnetic tape, hard disk drive), magneto-optical storage media (e.g., magneto-optical disk), CD-ROM (Read Only Memory), CD-R, CD-R/W, semiconductor memory (e.g., mask ROM, PROM (Programmable ROM), EPROM (Erasable PROM), flash ROM, and RAM (random Access memory)). Programs may also be supplied to a computer via any of various types of transitory computer-readable media. Examples of transitory computer-readable media include electric signals, optical signals and electromagnetic waves. A transitory computer-readable medium can supply programs to a computer through a wired communication channel such as wire and optical fiber or a wireless communication channel.

Some or all of the above example embodiments can be described as in the supplementary notes below but are not limited to the following.

### (Supplementary Note 1)

A computing machine including:

control managing means for controlling communication between a plurality of computing machines;

management register means for managing communication setting information which sets communication between the computing machines and communication state information which indicates a state of the communication; and

edge control means for, upon receiving a signal from one of the computing machines, sorting the signal into a control signal and data based on the communication setting information set in the management register means and in accordance with the number of clocks for processing the signal.

### (Supplementary Note 2)

The computing machine according to Supplementary note 1, wherein

when the control managing means sets the communication state information in the management register means to communication in progress, the edge control means transmits the signal to the computing machine; and

when the edge control means receives the signal from the computing machine, the edge control means sets the communication state information in the management register means to communication complete.

### (Supplementary Note 3)

The computing machine according to Supplementary note 1 or 2, wherein

the edge control means counts a data size of the data to be transmitted and transmits the signal containing the control signal to which the data size has been added and the data to the computing machine,

when the edge control means receives the signal, the edge control means counts the data size of the data contained in the received signal, and

when the counted data size agrees with the data size added to the control signal, the edge control means completes reception of the data and sets the communication state information in the management register means to communication complete.

### (Supplementary Note 4)

The computing machine according to Supplementary note 1 or 2, wherein

the communication setting information includes a data size of the data which is transmitted by the edge control means,

when the edge control means receives the signal, the edge control means counts the data size of received data, and

when the counted data size agrees with the data size contained in the communication setting information, the edge control means completes reception of the data and sets the communication state information in the management register means to communication complete.

### (Supplementary Note 5)

The computing machine according to any one of Supplementary notes 1 to 4, further including:

a memory which is connected with the edge control means and is configured to temporarily store data received by the edge control means,

wherein the edge control means transmits the control signal for notification of reception completion of the data to the computing machine after reception of the signal is completed and at a point when the memory is emptied.

### (Supplementary Note 6)

The computing machine according to any one of Supplementary notes 1 to 5, wherein the number of clocks for determining the control signal is preset.

### (Supplementary Note 7)

The computing machine according to any one of Supplementary notes 1 to 6, further including:

a save memory which is connected with the edge control means and is configured to store the data which is being transmitted by the edge control means to the computing machine,

wherein when an instruction on another communication is given during transmission of the signal, the edge control means stops the transmission of the signal and stores the data contained in the signal in the save memory.

### (Supplementary Note 8)

The computing machine according to any one of Supplementary notes 1 to 7, further including:

error register means for storing error information which has occurred in the computing machine,

wherein the edge control means transmits a plurality of consecutive control signals to the computing machine based on the error information.

### (Supplementary Note 9)

A parallel computing machine system formed by connection of at least a first computing machine and a second computing machine, wherein

when the first computing machine receives a signal from the second computing machine, the first computing machine sorts the signal into a control signal and data based on communication setting information which is preset for communication between the first computing machine and the second computing machine and in accordance with the number of clocks for processing the received signal.

### (Supplementary Note 10)

The parallel computing machine system according to Supplementary note 9, wherein

the first computing machine stores communication state information indicating a state of communication with the second computing machine,

when the communication state information is set to communication in progress, the first computing machine transmits a predetermined signal to the second computing machine, and

when the first computing machine receives a signal from the second computing machine, the communication state information is set to communication complete.

### (Supplementary Note 11)

A method including the steps of:

receiving, by a first computing machine, a signal from a second computing machine which executes parallel computation with the first computing machine; and

upon receiving the signal, sorting, by the first computing machine, the signal into a control signal and data based on communication setting information which is preset for communication between the first computing machine and the second computing machine and in accordance with the number of clocks for processing the received signal.

### (Supplementary Note 12)

A non-transitory computer-readable medium storing a program for causing a first computing machine to perform the steps of:

storing, by the first computing machine, a signal received from a second computing machine which executes parallel computation with the first computing machine; and

upon receiving the signal, sorting the signal into a control signal and data based on communication setting information which is preset for communication between the first computing machine and the second computing machine and in accordance with the number of clocks for processing the received signal.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

What is claimed is:

1. A computing machine comprising:
control managing means for controlling communication between a plurality of computing machines;
management register means for managing communication setting information which sets communication between the computing machines and communication state information which indicates a state of the communication; and
edge control means for, upon receiving a signal from one of the computing machines, sorting the signal into a control signal and data based on the communication setting information set in the management register means and in accordance with the number of clocks for processing the signal.

2. The computing machine according to claim 1, wherein
when the control managing means sets the communication state information in the management register means to communication in progress, the edge control means transmits the signal to the computing machine; and
when the edge control means receives the signal from the computing machine, the edge control means sets the communication state information in the management register means to communication complete.

3. The computing machine according to claim 1, wherein
the edge control means counts a data size of the data to be transmitted and transmits the signal containing the control signal to which the data size has been added and the data to the computing machine,
when the edge control means receives the signal, the edge control means counts the data size of the data contained in the received signal, and
when the counted data size agrees with the data size added to the control signal, the edge control means completes reception of the data and sets the communication state information in the management register means to communication complete.

4. The computing machine according to claim 1, wherein
the communication setting information includes a data size of the data which is transmitted by the edge control means,
when the edge control means receives the signal, the edge control means counts the data size of received data, and
when the counted data size agrees with the data size contained in the communication setting information, the edge control means completes reception of the data and sets the communication state information in the management register means to communication complete.

5. The computing machine according to claim 1, further comprising:
a memory which is connected with the edge control means and is configured to temporarily store data received by the edge control means,
wherein the edge control means transmits the control signal for notification of reception completion of the data to the computing machine after reception of the signal is completed and at a point when the memory is emptied.

6. The computing machine according to claim 1, wherein the number of clocks for determining the control signal is preset.

7. The computing machine according to claim 1, further comprising:
a save memory which is connected with the edge control means and is configured to store the data which is being transmitted by the edge control means to the computing machine,
wherein when an instruction on another communication is given during transmission of the signal, the edge control means stops the transmission of the signal and stores the data contained in the signal in the save memory.

8. A method comprising the steps of:
receiving, by a first computing machine, a signal from a second computing machine which executes parallel computation with the first computing machine; and
upon receiving the signal, sorting, by the first computing machine, the signal into a control signal and data based on communication setting information which is preset for communication between the first computing machine and the second computing machine and in accordance with the number of clocks for processing the received signal.

9. A non-transitory computer-readable medium storing a program for causing a first computing machine to perform the processes of:
storing, by the first computing machine, a signal received from a second computing machine which executes parallel computation with the first computing machine; and
upon receiving the signal, sorting the signal into a control signal and data based on communication setting information which is preset for communication between the first computing machine and the second computing machine and in accordance with the number of clocks for processing the received signal.
